(19) United States
(12) Patent Application Publication
(10) Pub. No.: US 2025/0026290 A1
(43) Pub. Date: Jan. 23, 2025

(54) VEHICLE BUMPER AND METHOD THEREFOR

(71) Applicants: HYUNDAI MOBIS CO., LTD., Seoul (KR); KOLONGLOTECH, INC., Seoul (KR)

(72) Inventors: Seong Kwon KIM, Yongin-si (KR); Hyung Jun NA, Seoul (KR); Jae Du NAM, Seoul (KR); Hyeong Gyun KIM, Seoul (KR)

(73) Assignees: HYUNDAI MOBIS CO., LTD., Seoul (KR); KOLONGLOTECH, INC., Seoul (KR)

(21) Appl. No.: 18/591,253

(22) Filed: Feb. 29, 2024

(30) Foreign Application Priority Data
Jul. 17, 2023 (KR) 10-2023-0092254

(51) Int. Cl. B60R 19/18; B60R 19/03

(52) U.S. Cl. CPC B60R 19/18; B60R 19/03; B60R 2019/1873

(57) ABSTRACT

A vehicle bumper and method therefor are provided. The vehicle bumper includes a panel part forming a part of a vehicle body of a vehicle, and a reinforcement part which is disposed on the panel part through a long fiber injection (LFI) process. The reinforcement part reinforces rigidity of the panel part.

### CROSS-REFERENCE TO RELATED APPLICATION(S)

This application claims the benefit under 35 USC § 119 of Korean Patent Application No. 10-2023-0092254, filed on Jul. 17, 2023, in the Korean Intellectual Property Office, the disclosures of which are incorporated herein by reference for all purposes.

### BACKGROUND

### 1. Field of the Invention

The present invention relates to a vehicle bumper and more particularly, to a vehicle bumper having a reinforcement part.

### 2. Description of Related Art

A bumper mounted on a vehicle is a structure for absorbing an impact in an event of a collision and is disposed at the front or rear of the vehicle in a longitudinal direction of the vehicle. Such a bumper may include a panel exposed to the outside and a backbeam coupled to the panel, which absorbs an impact and serves to reinforce rigidity of the panel.

Among them, since the backbeam should absorb the impact that occurs during a collision, the backbeam requires high rigidity and weight. In addition, since the backbeam is formed of a steel material or single composite (glass fiber), the backbeam is manufactured as a separate part and coupled to the panel. Accordingly, the vehicle bumper requires separate fixing parts such as brackets or stays for fixing the backbeam to the panel. Accordingly, there are problems that as a weight of the vehicle bumper increases, assembly time and costs increase, and replacement and repair costs and times for the backbeam and components supporting the backbeam increase.

In addition, a large amount of space is required inside the vehicle to install the backbeam due to the components for fixing the backbeam to the panel. This causes a limit in forming a shape of the bumper, and thus there is a problem of reducing a degree of design freedom of the vehicle.

### SUMMARY OF THE INVENTION

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

The present invention is directed to providing a vehicle bumper capable of satisfying weight reduction and rigidity by being replaced with a backbeam.

In a general aspect of the disclosure, a vehicle bumper includes a panel part forming a part of a vehicle body of a vehicle, and a reinforcement part which is disposed on the panel part through a long fiber injection (LFI) process, wherein the reinforcement part is configured to reinforce rigidity of the panel part.

The panel part may include a region that is exposed to the outside and a non-exposed region that is not exposed to the outside, and the reinforcement part may be formed through a foaming process after the non-exposed region of the panel part is coated with the reinforcement part.

The panel part may include a region that is exposed to the outside and a non-exposed region that is not exposed to the outside, and the reinforcement part may have a shape corresponding to a non-exposed region of the panel part.

The reinforcement part may include a main body part disposed on a non-exposed region of the panel part, and a protruding part protruding from the main body part in a direction from the panel part toward the reinforcement part.

The vehicle bumper may further include an absorbing member including a support part coupled to the non-exposed region of the panel part, and an absorbing part having a shape bent from an end portion of the support part, wherein the support part may be disposed between the non-exposed region of the panel part and the main body part of the reinforcement part.

The non-exposed region of the panel part and the support part of the absorbing member may be coated with the reinforcement part through the LFI process.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a rear perspective view illustrating a vehicle bumper according to one embodiment of the present invention;

FIG. 2 is an exploded perspective view illustrating the vehicle bumper according to one embodiment of the present invention;

FIG. 3 is a view illustrating a reinforcement part and an absorbing member of a vehicle bumper according to another embodiment of the present invention;

FIGS. 4 and 5 are cross-sectional views illustrating reinforcement parts and absorbing members of vehicle bumpers according to other embodiments of the present invention; and

FIG. 6 is a view illustrating another example of a main body part of a reinforcement part.

### DETAILED DESCRIPTION

Since the present invention allows various changes and has many embodiments, specific embodiments will be illustrated in the accompanying drawings and described. However, this is not intended to limit the present invention to the specific embodiments, and it is to be appreciated that all changes, equivalents, and substitutes that fall within the spirit and technical scope of the present invention are encompassed in the present invention.

Although the terms “first,” “second,” and the like may be used herein to describe various elements, these elements should not be limited by these terms. These terms are only used to distinguish one element from another element. For example, a second element could be termed a first element, and a first element could similarly be termed a second element without departing from the scope of the present invention. The term “and/or” includes any one or any combination of a plurality of associated listed items.

When a first element is referred to as being “connected” or “coupled” to a second element, it will be understood that the first element may be directly connected or coupled to the second element, or a third element may be present therebetween. In contrast, when an element is referred to as being “directly connected” or “directly coupled” to another element, it will be understood that there are no intervening elements.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under the other element, such a description may include a case in which the one element is formed at an upper side or a lower side with respect to the other element.

Terminology used herein is for the purpose of describing particular embodiments only and is not intended to limit the present invention. The singular forms are intended to include the plural forms, unless the context clearly indicates otherwise. In the present specification, it should be further understood that the terms “comprise,” “comprising,” “include,” and/or “including” used herein specify the presence of stated features, numbers, steps, operations, elements, and/or components but do not preclude the presence or addition of one or more other features, numbers, steps, operations, elements, components, and/or groups thereof.

Unless otherwise defined, all terms including technical and scientific terms used herein have meanings which are the same as meanings generally understood by those skilled in the art. Terms, such as those defined in commonly used dictionaries, should be interpreted as having meanings that are consistent with their meanings in the context of the relevant art and will not be interpreted in an idealized or overly formal sense unless expressly so defined here.

Hereinafter, a vehicle bumper will be described in detail with reference to the accompanying drawings, and components that are the same or correspond to each other will be denoted by the same or corresponding reference numerals in all drawings, and redundant descriptions will be omitted.

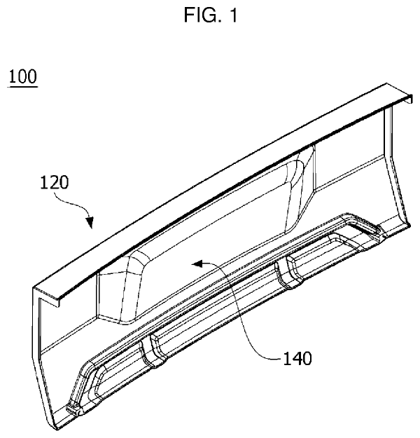

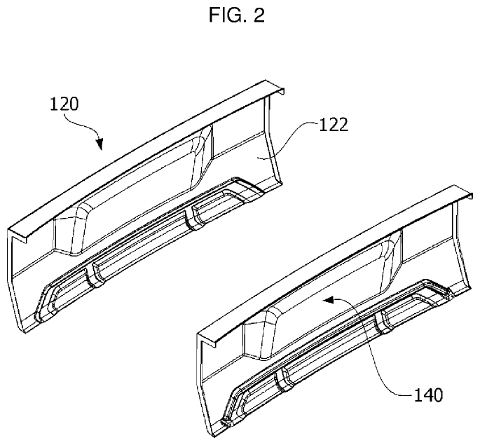

FIG. 1 is a rear perspective view illustrating a vehicle bumper according to one embodiment of the present invention, and FIG. 2 is an exploded perspective view illustrating the vehicle bumper according to one embodiment of the present invention.

Referring to FIGS. 1 and 2, a vehicle bumper 100 according to one embodiment of the present invention may include a panel part 120 and a reinforcement part 140.

The panel part 120 is a portion forming a part of a vehicle body of a vehicle and may include an exposed region exposed to the outside of the vehicle and a non-exposed region 122 which is not exposed to the outside of the vehicle. The panel part 120 may be formed of a plastic material with flexibility.

The reinforcement part 140 may be disposed in the non-exposed region 122 of the panel part 120. The reinforcement part 140 may be coupled to the non-exposed region 122 of the panel part 120 through a long fiber injection (LFI) process to reinforce rigidity of the panel part 120. A thickness of the reinforcement part 140 may correspond to a thickness of the panel part 120 but is not limited thereto.

The reinforcement part 140 may be formed through a foaming process after the non-exposed region 122 of the panel part 120 is coated with the reinforcement part.

More specifically, first, the panel part 120 is disposed on a worktable. In this case, the non-exposed region 122 of the panel part 120 is disposed not to face the worktable. Then, the LFI process is performed. The LFI process may be a process of coating a target object with a mixture of polyurethane (PU) and long glass fiber (LGF) (hereinafter, referred to as a mixture) using a gun capable of performing coating. Through the LFI process, the non-exposed region 122 of the panel part 120 is coated with the mixture. In this case, a thickness of the mixture with which the non-exposed region 122 of the panel part 120 is coated may be 2.5 mm but is not limited thereto, and the coating thickness of the mixture may be changed according to a thickness of the panel part 120 during a manufacturing process.

When the non-exposed region 122 of the panel part 120 is coated with the mixture, a mold which defines a shape of the reinforcement part 140 is disposed on the non-exposed region 122 of the panel part 120 coated with the mixture. After the mold is disposed on the non-exposed region 122 of the panel part 120, when the mold is pressed, the mixture may foam in a space between the non-exposed region 122 of the panel part 120 and the mold. Accordingly, the mixture may be formed in a shape corresponding to a space formed by the non-exposed region 122 of the panel part 120 and the mold. Accordingly, a shape of the reinforcement part 140 may be completely formed in a state in which the reinforcement part 140 is coupled to the non-exposed region 122 of the panel part 120.

Then, a process of removing the mold from the reinforcement part 140, of which the shape is completely formed, and the panel part 120 is performed, and then a trimming process of trimming edges of the panel part 120 and the reinforcement part 140 is performed so that the manufacture of the vehicle bumper 100 is ultimately completed.

The reinforcement part 140 may have the shape corresponding to the non-exposed region 122 of the panel part 120. Accordingly, the reinforcement part 140 may be stably fixed to the panel part 120. In addition, in the vehicle bumper 100 according to one embodiment of the present invention including the reinforcement part 140, since the reinforcement part 140 is formed through the LFI process, a requirement of a backbeam formed of steel material having a heavy weight and a structure which supports the backbeam is removed, thereby reducing a weight of the vehicle.

Hereinafter, a vehicle bumper 200 according to another embodiment of the present invention will be described. When describing the vehicle bumper 200 according to another embodiment of the present invention, the same parts as those of the vehicle bumper 100 according to one embodiment of the present invention will be denoted by the same reference numerals, and descriptions thereof will be omitted.

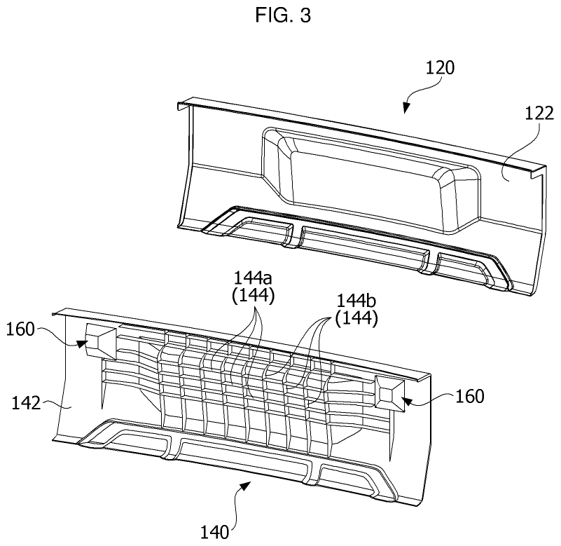

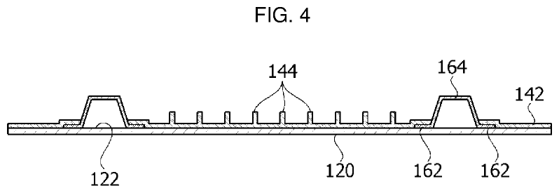

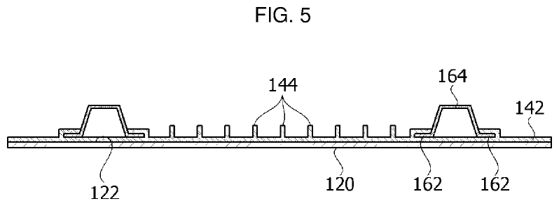

FIG. 3 is a view illustrating a reinforcement part and an absorbing member of a vehicle bumper according to another embodiment of the present invention, and FIGS. 4 and 5 are cross-sectional views illustrating reinforcement parts and absorbing members of vehicle bumpers according to other embodiments of the present invention.

Referring to FIGS. 3 and 4, the vehicle bumper 200 according to another embodiment of the present invention may include a panel part 120, a reinforcement part 140, and an absorbing member 160.

Since the panel part 120 is the same as the panel part 120 of the vehicle bumper 100 according to one embodiment of the present invention, the description thereof will be omitted.

The reinforcement part 140 may include a main body part 142 and a protruding part 144. The reinforcement part 140 may be disposed in a non-exposed region 122 of the panel part 120. The main body part 142 may have a shape corresponding to a shape of the non-exposed region 122 of the panel part 120. The protruding part 144 may be disposed on the panel part 120.

The protruding part 144 may protrude from the main body part 142 in a direction from the panel part 120 toward the reinforcement part 140. The protruding part 144 may be provided as a plurality of protruding parts 144 disposed on the panel part 120, and the plurality of protruding parts 144 may be disposed to be spaced a predetermined distance from each other.

The protruding parts 144 may include a first protruding part 144a and a second protruding part 144b. As illustrated in FIG. 3, the first protruding part 144a may be formed in a shape having a length in a direction from one absorbing member 160 toward another absorbing member 160. The second protruding part 144b may be formed in a shape having a length in a direction intersecting the direction in which the first protruding part 144 is disposed.

Since the first protruding part 144a and the second protruding part 144b are provided as a plurality of first protruding parts 144a and a plurality of second protruding parts 144b, the protruding parts 144 may form a lattice structure. Accordingly, the overall rigidity of the reinforcement part 140 can be improved, and the rigidity of the panel part 120 coupled to the reinforcement part 140 can also be improved.

In the present embodiment, it is illustrated that the first protruding part 144a is formed in the shape having the length in the direction from one absorbing member 160 toward another absorbing member 160, and the second protruding part 144b is formed in the shape having the length in the direction intersecting the direction in which the first protruding part 144a is disposed, but the present invention is not limited thereto. The first protruding part 144a may have the same shape as the second protruding part 144b, and the second protruding part 144b may have the same shape as the first protruding part 144a.

The absorbing member 160 may be disposed on each of both end portions of the reinforcement part 140 in a longitudinal direction. That is, the absorbing member 160 may be provided as a plurality of absorbing members 160. The absorbing member 160 called a stay or bumper stay may serve to absorb an impact applied to the panel part 120 when the panel part 120 is impacted. The absorbing member 160 may include a support part 162 and an absorbing part 164.

The support part 162 may be coupled to the non-exposed region 122 of the panel part 120. The absorbing part 164 may have a shape bent from an end portion of the support part 162 and have a wedge shape of which one end is cut.

As illustrated in FIG. 4, the non-exposed region 122 of the panel part 120 and the support part 162 of the absorbing member 160 may be coated with the reinforcement part 140 through an LFI process. The non-exposed region 122 of the panel part 120 and the absorbing member 160 are coated with a mixture, in which PU and LGF are mixed, using a gun, and, in this case, the mixture may connect the non-exposed region 122 of the panel part 120 and the support part 162 of the absorbing member 160.

In this state, when a mold presses the mixture, the reinforcement part 140 may be formed in a shape illustrated in FIGS. 3 and 4. A main body part 142 of the reinforcement part 140 may cover the support part 162 of the absorbing member 160. Accordingly, the reinforcement part 140 can prevent a phenomenon in which the support part 162 of the absorbing member 160 is separated from the panel part 120 or the reinforcement part 140.

The support part 162 may be disposed between the non-exposed region 122 of the panel part 120 and the main body part 142 of the reinforcement part 140. More specifically, as illustrated in FIG. 4, the support part 162 may be supported by the non-exposed region 122 of the panel part 120 and the main body part 142 of the reinforcement part 140. Accordingly, the support part 162 fixed to the panel part 120 and the reinforcement part 140 can improve the stability of the absorbing member 160.

As illustrated in FIG. 5, a support part 162 may be clamped by a main body part 142. More specifically, the main body part 142 may be disposed between the support part 162 and a non-exposed region 122 of a panel part 120. Accordingly, the support part 162 may be disposed to be spaced apart from the panel part 120. Accordingly, an effect of adding one impact absorbing layer can be obtained.

As described above, unlike the conventional vehicle bumper 100, which uses various types of components for fixing the absorbing member 160, the absorbing member 160 in the vehicle bumper 200 according to another embodiment of the present invention can be fixed only by the reinforcement part 140 with which the non-exposed region 122 of the panel part 120 is coated. Accordingly, manufacturing or purchasing costs for separate components for fixing the absorbing member 160 and costs for manufacturing with the separate components can be reduced.

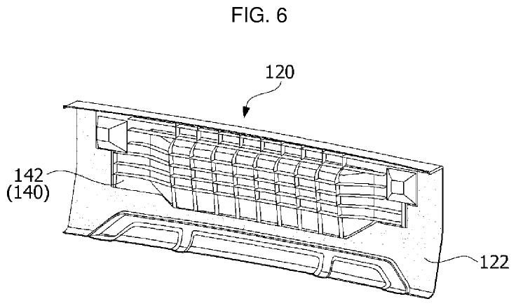

FIG. 6 is a view illustrating another example of a main body part of a reinforcement part.

Referring to FIG. 6, a main body part 142 may be disposed only on a region in which high rigidity is required in a panel part 120. That is, in a process of forming a reinforcement part 140, a partial region in a non-exposed region 122 of the panel part 120 may be coated with a mixture. Accordingly, a coating amount of the mixture may be reduced, and thus manufacturing costs can be reduced. Accordingly, since a low weight can also be implemented, a weight of a vehicle can be reduced.

According to one embodiment of the present invention, since a weight of a vehicle bumper is reduced using a reinforcement part, a weight of a vehicle can be reduced, and thus a manufacturing cost and time of the bumper can be reduced.

In addition, since a vehicle bumper using a reinforcement part can have rigidity to correspond to that of the conventional backbeam, the vehicle bumper can achieve a level of component damage prevention comparable to that of the backbeam.

While the present invention has been described above with reference to exemplary embodiments, it may be understood by those skilled in the art that various modifications and changes of the present invention may be made within a range not departing from the spirit and scope of the present invention defined by the appended claims. In addition, it should be interpreted that differences related to such modifications and applications fall within the scope of the present invention defined by the appended claims.

What is claimed is:

1. A vehicle bumper comprising:
a panel part forming a part of a vehicle body of a vehicle; and
a reinforcement part which is disposed on the panel part through a long fiber injection (LFI) process,
wherein the reinforcement part is configured to reinforce rigidity of the panel part.

2. The vehicle bumper of claim 1,
wherein the panel part includes a region that is exposed to the outside and a non-exposed region that is not exposed to the outside, and
wherein the reinforcement part is formed through a foaming process after the non-exposed region of the panel part is coated with the reinforcement part.

3. The vehicle bumper of claim 1,
wherein the panel part includes a region that is exposed to the outside and a non-exposed region that is not exposed to the outside, and
wherein the reinforcement part has a shape corresponding to a non-exposed region of the panel part.

4. The vehicle bumper of claim 1, wherein the reinforcement part includes:
a main body part disposed on a non-exposed region of the panel part; and
a protruding part protruding from the main body part in a direction from the panel part toward the reinforcement part.

5. The vehicle bumper of claim 4, further comprising:
an absorbing member including:
a support part coupled to the non-exposed region of the panel part; and
an absorbing part having a shape bent from an end portion of the support part,
wherein the support part is disposed between the non-exposed region of the panel part and the main body part of the reinforcement part.

6. The vehicle bumper of claim 5, wherein the non-exposed region of the panel part and the support part of the absorbing member are coated with the reinforcement part through the LFI process.
